(19) United States
(12) Patent Application Publication
(10) Pub. No.: US 2008/0029324 A1
(43) Pub. Date: Feb. 7, 2008

(54) SNOW VEHICLE

(75) Inventor: Daniel J. Plankenhorn, Milwaukee, WI (US)

Correspondence Address: BLACK LOWE & GRAHAM, PLLC, 701 FIFTH AVENUE, SUITE 4800, SEATTLE, WA, 98104, US

(73) Assignee: Thorr Action Sports, Inc., Milwaukee, WI (US)

(21) Appl. No.: 11/625,939

(22) Filed: Jan. 23, 2007

Related U.S. Application Data
(60) Provisional application No. 60/761,068, filed on Jan. 23, 2006.

(51) Int. Cl. B62B 13/02; B62D 55/07; B62M 27/02

(52) U.S. Cl. 180/190; 280/12.14; 280/22.1

(57) ABSTRACT

A ski vehicle includes two front terrain engagement devices, such as front skis, and a rear terrain engagement device, such as a rear ski. The ski vehicle includes a steering assembly having a linkage system. A configuration of the linkage system in combination with rotation of the steering assembly about a single rake axis may advantageously improve the stability, turning efficiency, control, and responsive of the ski vehicle during maneuvers and on sloped surfaces. The linkage system, and possibly in combination with auxiliary linkage loading devices, permits the front skis to operate in parallel and to individually tilt and thrust forward relative to one another.

### PRIORITY CLAIM

The present application claims priority from U.S. Provisional Application No. 60/761,068 filed Jan. 23, 2006, which is herein incorporated by reference.

### FIELD OF THE INVENTION

The present invention generally pertains to a snow vehicle having terrain engagement devices, for example skis for recreationally moving over snow.

### BACKGROUND OF THE INVENTION

Conventional ski vehicles typically include a front steerable ski, handlebars, a seat, and at least one rear ski. On these types of ski vehicles, the rider wears short foot skis to improve stability and control of the ski vehicle. Other ski vehicles may include two front skis and one rear ski or one front ski and two rear skis. Generally, these so-called tri-ski vehicles provide added stability, but are less responsive and more difficult to control than the conventional two-ski vehicles. Another drawback of the tri-ski vehicles is the configuration and/or loading of the front skis, which in turn affects the balance and maneuverability of the ski vehicle.

Various attempts have been made in the past to improve upon the ski vehicle concept. Many of these attempts are described in the background section of U.S. Patent Publication No. 2006/0151965 to Calitz, and which is incorporated by reference herein.

It would be desirable to have a tri-ski vehicle with improved stability and control features. In addition, it would be desirable to have a tri-ski vehicle with a structural configuration that advantageously affects the dynamics of the vehicle during both sharp and subtle turning maneuvers over varied terrain.

### SUMMARY OF THE INVENTION

According to at least one embodiment of the invention, a ski vehicle includes a rear ski and two front skis couple to a main frame. The two front skis are coupled to a linkage system and a steering assembly arranged and rotatable about a rake axis. The arrangement of the linkage system and the steering assembly advantageously provides improved steering, handling, turning, ski edging, and responsiveness of the ski vehicle over varied terrain.

In one aspect of the invention, a ski vehicle includes a frame, a seating apparatus coupled to the frame, a rear terrain engagement device coupled to an aft portion of the frame, two front terrain engagement devices, and a steering assembly rotationally coupled to the frame and coupled to the two front terrain engagement devices. The steering assembly includes a linkage system and at least a portion of the steering assembly and the linkage system are cooperatively rotatable about a rake angle to maneuver the two front terrain engagement devices in tandem.

In another aspect of the invention, a ski vehicle includes a frame, a seating apparatus coupled to the frame, a rear ski coupled to an aft portion of the frame, two front skis, and a steering assembly rotationally coupled to the frame and coupled to the two front skis. The steering assembly includes a linkage system where at least a portion of the steering assembly and the linkage system are cooperatively rotatable about a rake angle to maneuver the two front skis in tandem. In addition, the steering assembly and the linkage system are cooperatively rotatable about the rake angle to provide a desired edging orientation for at least one of the two front skis.

In still yet another aspect of the invention, a ski vehicle may be converted from a bicycle frame and other bicycle components. A conversion kit includes a bicycle frame modifiable for attachment to at least one rear ski and two front skis. The conversion kit further includes a steering assembly for rotational attachment to the frame and for attachment to the two front skis. The steering assembly includes a linkage system where at least a portion of the steering assembly and the linkage system, after attachment to the frame, would be cooperatively rotatable about a rake angle to maneuver the two front skis in tandem and provide a desired edging orientation for at least one of the two front skis.

### BRIEF DESCRIPTION OF THE DRAWINGS

The preferred and alternative embodiments of the present invention are described in detail below with reference to the following drawings:

FIG. 1 is an perspective view of a ski vehicle having a steering assembly coupled to a linkage system along a desired rake angle according to an embodiment of the invention;

FIGS. 2A-2C show schematic, front-elevational views of various arrangements for a four-bar linkage system;

FIG. 3 shows a schematic, front-elevational view of a linkage system having a higher degree of kinematic complexity than the four-bar linkage system of FIG. 2A;

FIG. 4A is an side-elevational view of a ski vehicle having a seating apparatus rotationally coupled to a main frame of the ski vehicle and supported by a damping device positioned between the seating apparatus and a rear ski according to an embodiment of the invention;

FIG. 4B is the ski vehicle of FIG. 4A showing a rider in a recumbent seating position;

FIG. 5A shows a plan, schematic view of a conventional two-ski type of ski vehicle illustrating a support base over which a combined center of mass of the rider and the ski vehicle may be balanced when effecting a turn of the ski vehicle;

FIG. 5B shows a plan, schematic view of a three-ski type of ski vehicle illustrating a support base over which a combined center of mass of the rider and the ski vehicle may be balanced when effecting a turn of the ski vehicle;

FIGS. 6A-6C show the ski vehicle of FIG. 4A in operation over varied terrain;

FIG. 7 shows a perspective view of another ski vehicle assembled from a bicycle or a modified bicycle frame according to an embodiment of the invention;

FIGS. 8A-8E show schematic front-elevational views of a linkage system with various forms of restraining and/or restoring devices attached to the linkage system;

FIG. 9 shows a perspective view of a ski loading apparatus according to an embodiment of the invention;

FIG. 10 shows a perspective view of a skeg coupled to a ski vehicle according to an embodiment of the invention;

FIG. 11 shows a side-elevational view of a motorized system for a ski vehicle according to an embodiment of the invention;

FIG. 12A shows a perspective view of a human-powered ski vehicle according to an embodiment of the invention; and

FIG. 12B shows another perspective view of the human-powered ski vehicle of FIG. 12A.

### DETAILED DESCRIPTION OF THE PREFERRED EMBODIMENT

In the following description, certain specific details are set forth in order to provide a thorough understanding of various embodiments of the invention. In other instances, well-known structures and methods associated with ski vehicles and methods of using, making and/or assembling the same may not be shown or described in detail to avoid unnecessarily obscuring descriptions of the embodiments of the invention.

The following description generally relates to a ski vehicle having two front skis and a rear terrain engagement device. The ski vehicle advantageously provides improved stability and more effective control during the dynamic loading that occurs during turning and positioning. The improved stability and control of the ski vehicle is achieved by the sharp, deep edging of the two front skis, which function together in a coordinated fashion through a pivotally interconnected linkage system and complimented by configuring a steering assembly to have a rake angle.

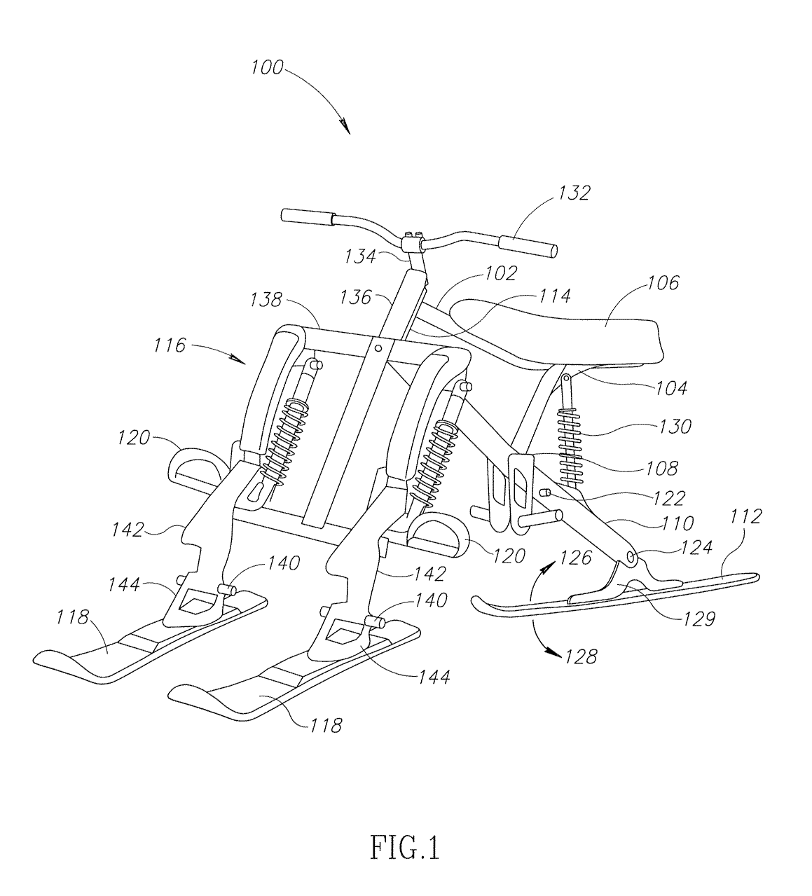

FIG. 1 shows a ski vehicle according to an embodiment of the invention. The ski vehicle 100 includes a main frame 102. An upper, aft portion 104 of the main frame 102 is coupled to a seating apparatus 106 and a lower, aft portion 108 of the main frame 102 is pivotally coupled to a swing arm 110. The swing arm 110 is coupled to a rear terrain engagement device 112. A fore portion 114 of the main frame 102 is coupled to a steering assembly 116, which in turn is coupled to two front terrain engagement devices 118. The illustrated embodiment shows the rear terrain engagement device 112 and the two front terrain engagement devices 118 as skis. The skis may be, but are not limited, to “shaped” or parabolic skis for enhancing the turning capability and responsiveness of the ski vehicle 100. Alternatively, the two front terrain engagement devices 118 may be cross country skis or blades, where the latter permits the ski vehicle 100 to be used on ice. For the sake of clarity and brevity, the rear terrain engagement device 112 and the two front terrain engagement devices 118 will be referred to as skis throughout this most of this description. However, other embodiments, as described later, may use other devices in lieu of skis and will be identified accordingly.

The main frame 102 functions as a structural load path to distribute the rider's weight to the rear ski 112 and to the two front skis 118. The main frame 102 may take a variety of forms and may be made from a variety of materials (e.g., steel, aluminum, titanium, fiber-reinforced composite, etc.). In one embodiment, as described in more detail later, the main frame 102 is a bicycle frame that may have been converted or modified to be used for the ski vehicle 100. Likewise, the seating apparatus 106 may take a variety of forms, for example the seating apparatus may be a bicycle seat. In addition, the seating apparatus 106 may be arranged in a recumbent position that permits the rider to place their feet in or on foot pegs, supports, peddles or stirrups 120 affixed to the steering assembly 116. Placement of the rider's feet of the foot pegs 120 allows the rider to preferentially weight one of the two front skis 118 and thus achieve improved control over the dynamic weight distribution on the two front skis 118. This preferentially weighting may be especially helpful, for example, during turning and traversing maneuvers and when riding over sloping or uneven terrain.

The swing arm 110 permits the rear ski 112 to rotate relative to the main frame 102 through a first pivot joint 122. In addition, a second pivot joint 124 located on the swing arm 110 allows the rear ski 112 to pitch in an upward direction 126 or a downward direction 128, which provides another degree of freedom for the rear ski 112. In the illustrated embodiment, a bracket 129 provides a fixed attachment to the rear ski 112 and further provides a pivot attachment to the swing arm 110 about the second pivot joint 124. Permitting the rear ski 112 to pitch may advantageously improve the handling characteristics of the ski vehicle 100 while reducing or eliminating the possibility of structural damage (e.g., fatigue cracks, fractured attachment interfaces, etc.) in the ski vehicle. In addition, a biasing member or shock absorber 130 may be located between the seating apparatus 106 and the swing arm 110 to provide a more comfortable ride, and improve engagement time between the ski vehicle 100 and the terrain.

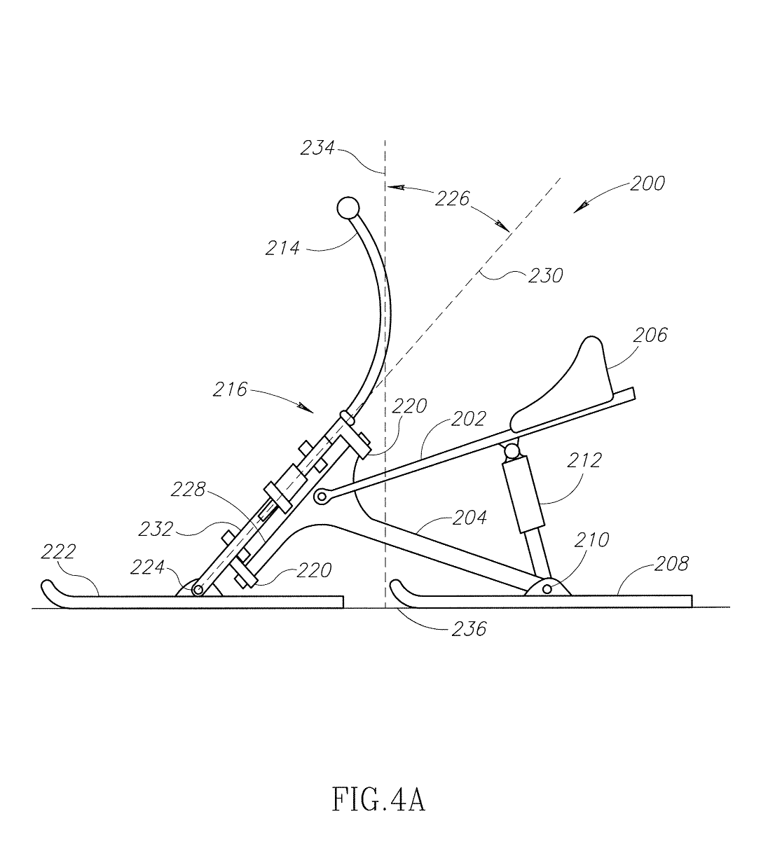

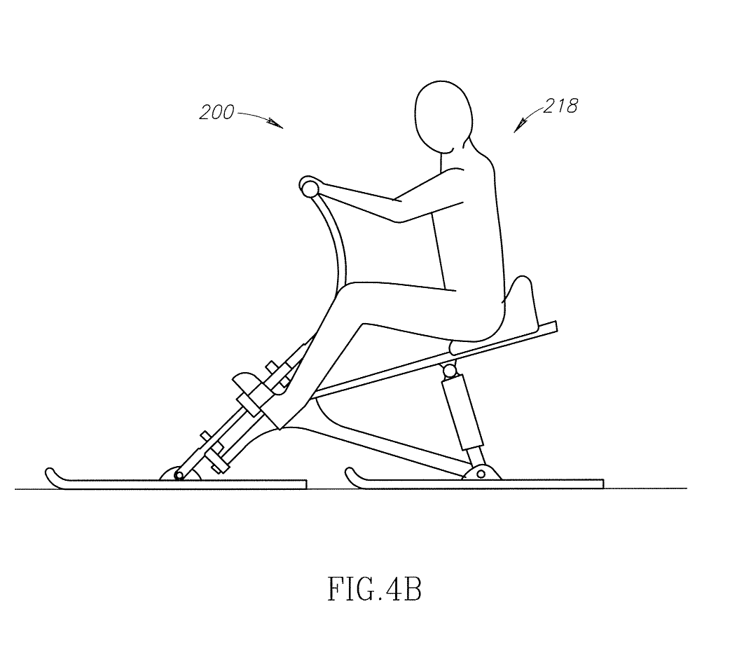

The steering assembly 116 includes a grippable steering apparatus 132, a stem, 134, a steering post 136 and a linkage assembly 138. The steering assembly is rotationally coupled to the fore portion 114 of the main frame 102 via the steering post 136. The linkage assembly 138 is pivotally coupled to the steering post 136, as will be described in greater detail below. The orientation of the steering post 136 and the linkage assembly 138 generally determines the rake angle 226 (FIG. 4A). The linkage assembly 138 is pivotally coupled to the front skis 118 through a front ski pivot joint 140 located at an interface between a support member 142 and a front ski bracket 144. The grippable steering apparatus 132 may take a variety of forms. By way of example, the grippable steering apparatus 132 may be a set of handlebars.

In operation, the yoke or stem 134 primarily carries torsional loads from the grippable steering apparatus 132 to the steering post 136. In the illustrated embodiment, movement of the handlebars 132 causes the linkage system 138 and the two front skis 118 to rotate about a rake axis 230 (FIG. 4A). The stem 134 may also carry other loads, for example the stem 134 may carry a portion of the rider's weight when the rider leans on the grippable steering apparatus 132.

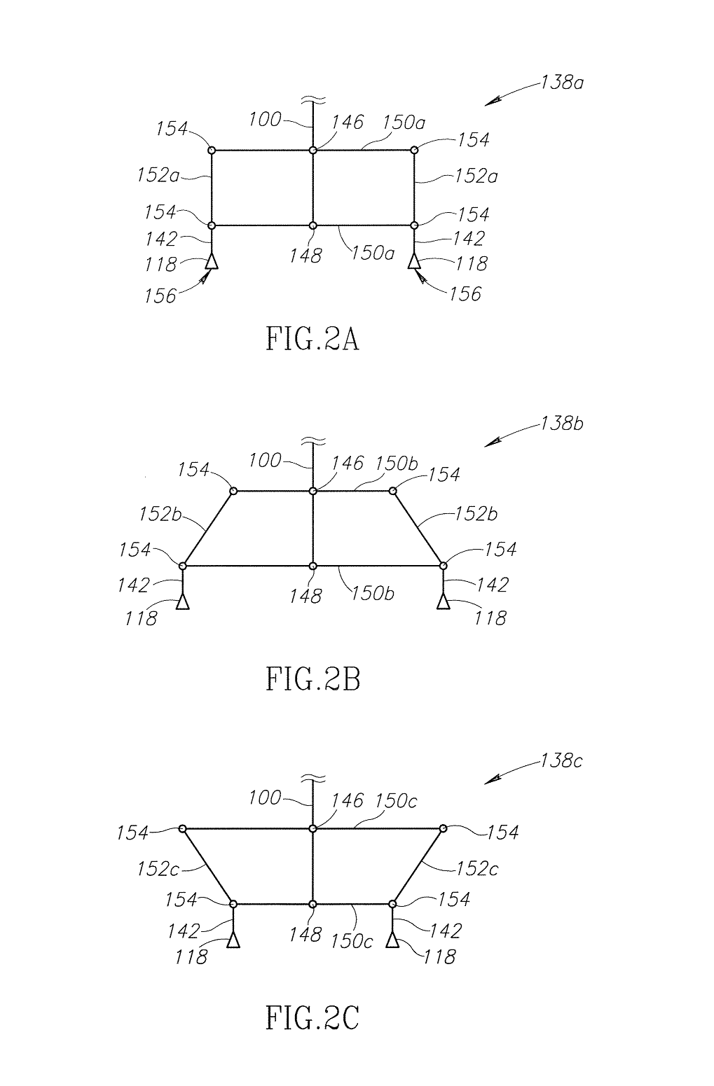

FIGS. 2A, 2B, and 2C schematically show various embodiments of the linkage system 138 from FIG. 1. One common attribute of the linkage systems 138 is that they are pivotally coupled to the ski vehicle 100 through an upper linkage pivot joint 146 and a lower linkage pivot joint 148. Another common attribute is that the linkage systems 138 are coupled to the front skis 118 by way of the support members 142.

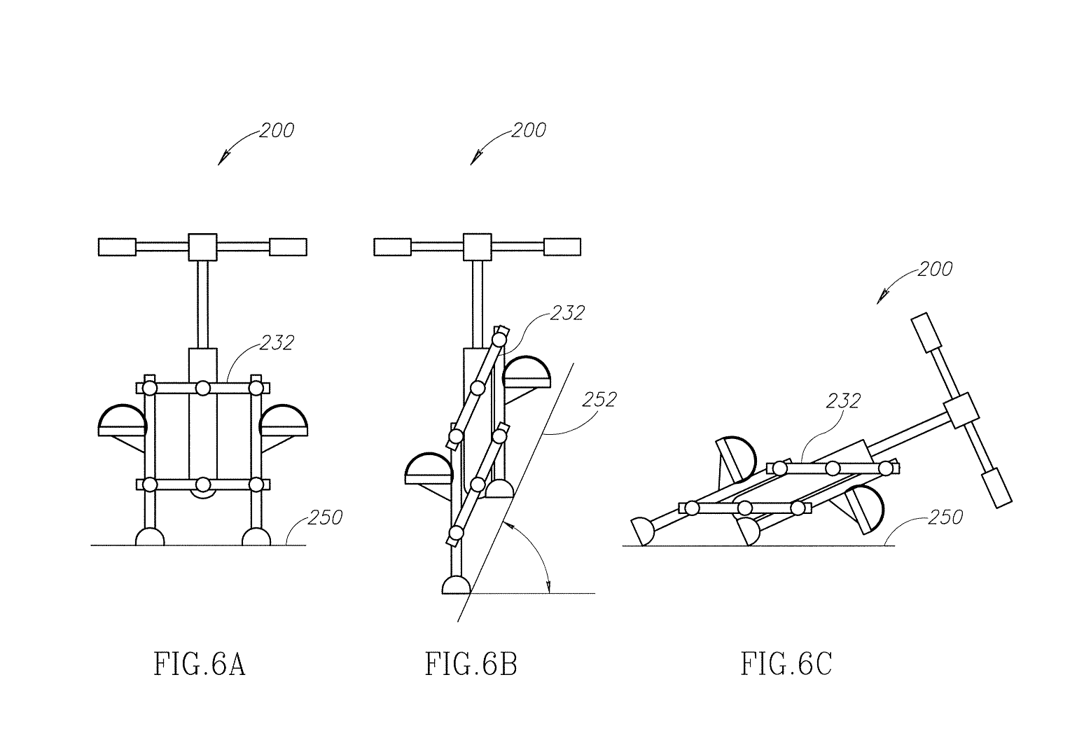

In FIG. 2A, the linkage system 138a, which may be referred to as a four-bar linkage system or parallelogram linkage system, includes parallel, same-length horizontal links 150a and parallel, same-length side links 152a. The linkage system 138a, in addition to rotating relative to the ski vehicle 100 via joints 146, 148, the links 150a, 152a are pivotally interconnected through corner pivot joints 154. It is appreciated that the side links 152a may be fixedly attached or integrally formed with the support members 142 such that the side link 152a and the support members 142 always remain aligned. Because the linkage system 138a is a parallelogram linkage system, bottom surfaces 156 of each of the front skis 118 will remain substantially parallel when the ski vehicle 100 is maneuvered on a sloped surface or during a turn. This kinematic motion is best illustrated in FIGS. 46A through 6C for at least one embodiment of a parallelogram linkage system.

In FIG. 2B, a linkage system 138b includes parallel, different-length horizontal links 150b and non-parallel, same-length side links 152b. The linkage system 138b, in addition to rotating relative to the ski vehicle 100 via joints 146, 148, the links 150b, 152b are pivotally interconnected through corner pivot joints 154. In the illustrated embodiment, the upper link is shorter than the lower link. Because of the non-parallel arrangement of the linkage system 138b, the bottom surfaces 156 of each of the front skis 118 may be skewed (i.e., non-parallel with one another) when the ski vehicle 100 is maneuvered on a sloped surface or during a turn. However, it should be noted that the skis 118, themselves, will maintain their parallel, spaced-apart relationship to one another (i.e., along a longitudinal axis of the ski 118) because the skis 118 are structurally constrained by the linkage system 138b. By way of example, during a turn the bottom surface 156 of an inside ski 118 will be at a different angle relative to the terrain when compared to the bottom surface 156 of an outside ski 118. Consequently, the linkage system 138b may provide additional advantages with respect to ski edging and overall vehicle responsiveness on varied terrain.

In FIG. 2C, a linkage system 138c includes parallel, different-length horizontal links 150c and non-parallel, same-length side links 152c. The linkage system 138c, in addition to rotating relative to the ski vehicle 100 via joints 146, 148, the links 150c, 152c are pivotally interconnected through corner pivot joints 154. In the illustrated embodiment, the upper link is longer than the lower link. Because of the non-parallel arrangement of linkage system 138c, the bottom surfaces 156 of each of the front skis 118 may be skewed (i.e., non-parallel) when the ski vehicle 100 is maneuvered on a sloped surface or during a turn. Similar to the aforementioned embodiment of FIG. 2B, the linkage system 138c may provide additional, yet opposite kinematic advantages with respect to ski edging and overall vehicle responsiveness on varied terrain.

The aforementioned embodiments indicate that depending on the design goals for the ski vehicle, it may be advantageous to change the relationship of the length of the upper link with respect to the lower link in the four bar linkage system. The linkage system generally provides for dual, linked-in-parallel (DLP) front skis that may able to individually tilt with respect to each other, for example in some embodiments the two front skis will tilt at different rates when the ski vehicle is turned or moves over uneven terrain. As previously noted, one potential advantage is that the difference in tilt angles between the bottom surfaces of the two skis, if planned and controlled, is expected to improve ski edging, enhanced steering control, and improve responsiveness of the ski vehicle.

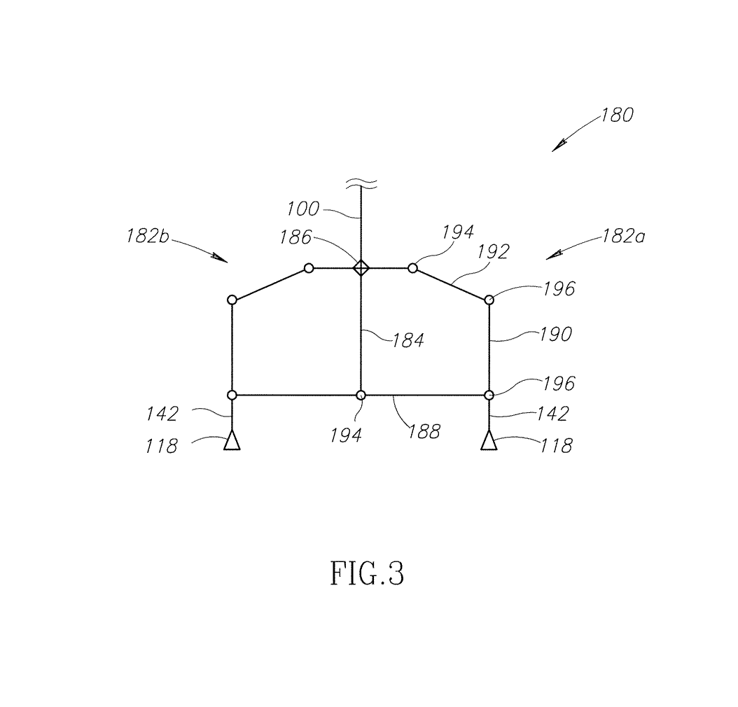

FIG. 3 shows another embodiment of a linkage system 180, which may be appreciated as two four-bar linkage systems 182a, 182b coupled to a shared link 184 having a fixed joint 186. For purposes of brevity, only one half to the linkage system 180 will be described since the linkage system 180 is symmetrical with respect to its structural configuration. The linkage system includes the shared link 184, a lower link 188, a side link 190, and an upper link 192. The linkage system 180 rotates relative to the ski vehicle 100 about first pivot joints 194 and translates relative to the ski vehicle 100 due to operation of second pivot joints 196.

The location and position of additional links within the linkage system may further enhance the tilting effect described above. Moreover, additional links, as well as variations in their relative lengths and variations in fixity between selected pivot points, are expected to achieve other dynamic and/or kinematic changes to produce a specific “tilt path” or “angular motion signature” for a given arrangement.

FIG. 4A shows another ski vehicle 200 according to an embodiment of the invention. In this embodiment, a seat support member 202 is pivotally coupled to a main frame 204. The seat support member 202 supports a seating apparatus 206. The main frame 204 is pivotally coupled to a rear ski 208 about a rear ski pivot joint 210. Further, an energy absorbing device 212 is positioned between the seating apparatus 206 and the rear ski 208. In one embodiment, the energy absorbing device 212 is a pneumatic shock absorber. Curved handlebars 214, which are part of a steering assembly 216, may be provided to ergonomically accommodate the rider in a recumbent seating position 218 (FIG. 4B). In turn, the recumbent seating position 218 advantageously located the rider's center of mass closer to the terrain.

In the illustrated embodiment of FIG. 4A, the steering assembly 216 is rotationally coupled to the main frame 204 at pivot joints 220. The steering assembly 216 is pivotally coupled to a pair of front skis 222 at front ski pivot joint 224. A rake angle 226 for the steering assembly 216 is defined as the forward/backward or fore/aft tilt angle of the steering assembly 216, which corresponds with the fore/aft tilt angle of a front portion 228 of the main frame 204. The steering assembly 216 and thus the front skis 222 rotate about a rake axis 230 when maneuvering or turning the ski vehicle 200. The amount of fore/aft tilt of the rake angle 226 cooperates a linkage system 232 such that the two front skis 222 rotate in tandem about the rake axis 230 to advantageously allow the rider to achieve improved ski edging and dynamic positioning of the ski vehicle during maneuvers.

The rake angle 226 is taken from a vertical line 234 extending normal from a terrain surface 236. Preferably, but not required, the rake angle 226 should be greater than 20 degrees from the vertical line 234. In one preferred embodiment, the rake angle 226 is in a range of about 30-45 degrees from the vertical line 234, which provides a flatter rake angle when compared to conventional ski vehicles or bicycles. It has been determined that a flatter rake angle (i.e., a rake angle greater than 20 degrees) may advantageously result in steeper edging and better carving for the front skis 222, but only up to a critical point. At the critical point, the advantages in turning performance begin to drop off. Depending on the size, weight, rider skill, snow conditions, slope angle, difficulty of terrain, etc., of the ski vehicle 200, it is appreciated that there may be an optimum orientation for the rake angle 226 to comfortably accommodate the seated rider while still providing the aforementioned advantages.

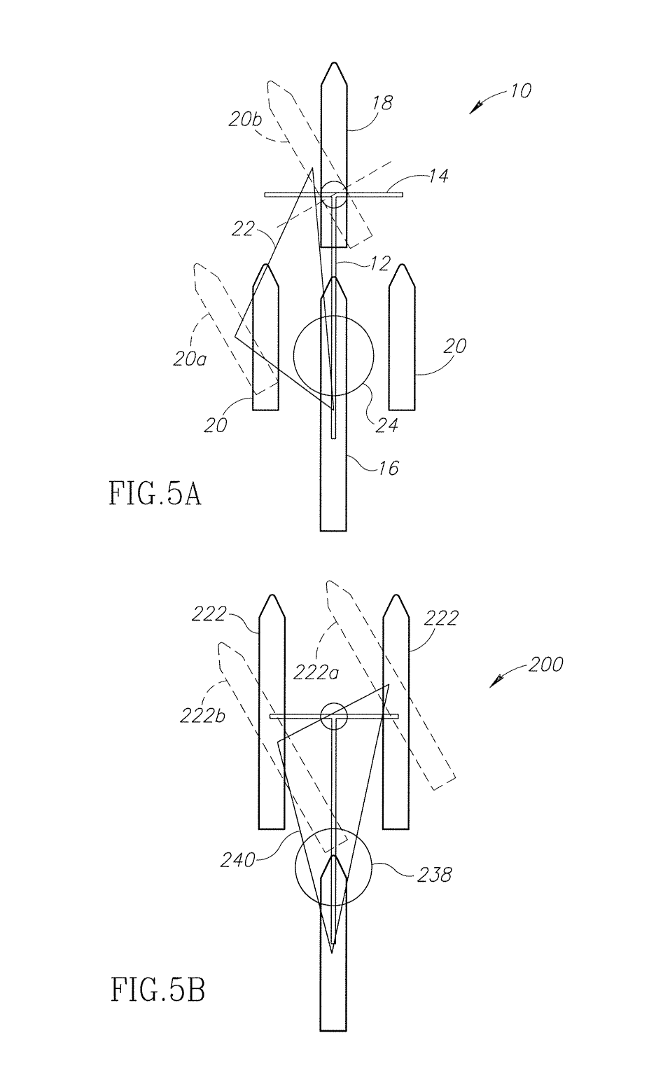

FIGS. 5A and 5B contrastingly and schematically show some of the advantages in steering and balance performance of the ski vehicle 200 (FIG. 5B) in comparison to a conventional ski vehicle 10 (FIG. 5A). In FIG. 5A, the conventional ski vehicle 10 includes a frame 12 coupled to a steering system 14 and to a rear ski 16. The steering system 14 is coupled to a front ski 18. Two foot skis 20 are worn by a rider (not shown). The foot skis 20 permit the rider to steer, balance, and maneuver the ski vehicle 10 by human dynamics, such as body motion, weight shifts, deeper edging with an inside foot ski 20a during a turn, etc.

By way of example and as illustrated in FIG. 5A, the configuration of the ski vehicle 10 determines a shape of a support base 22, which provides a stability region when the vehicle makes a turn or other maneuver. The support base 22 for the single front and single rear type of ski vehicle 10 is indicated by the forward pointing, triangular support base 22 over which a combined center of mass (hereinafter “combined COM”) 24 for both the vehicle and the rider can be supported during the turn or maneuver. During the turn, the rider must quickly adjust the foot skis 20 to an inside foot position 20a and an outside foot ski position 20b to maintain stability and control over the ski vehicle 10 and to utilize the narrower support base 22.

FIG. 5B schematically shows that the ski vehicle 200 provides advantages in steering and balance performance of the conventional ski vehicle of FIG. 5A, in part, because of the tandem rotation of the two front skis 222 about the rake axis 230 (FIG. 4A). During turning and/or maneuvering on sloped or uneven terrain, the front skis 222 change positions to an outside ski 222a, which is thrust forward with respect to an inside ski 222b. This forward-thrusting, re-positioning of outside ski 222a relative to the inside ski 222b permits the rider to better control dynamic positioning of a combined COM 238. In addition, the tri-ski arrangement of the ski vehicle 200 provides a more stable, larger support base 240 in comparison with the conventional ski vehicle 10, especially during turns and maneuvers. In sum, the ski vehicle 200 has substantially better steering and balance performance for the rider during turns and/or when maneuvering over uneven and/or sloped terrain because of three-ski configuration (i.e., two front skis and one rear ski) and because the rake angle 226 (FIG. 4A) cooperates with the linkage system 232 (FIG. 4A) to rotate about a rake axis 230 (FIG. 4A).

FIGS. 6A, 6B, and 6C show the ski vehicle 200 in operation on a level terrain surface 250 (FIG. 6A), on a sloped surface 252 (FIG. 6B) and on the level terrain surface 250 while making a sharp turn (FIG. 6C). These figures show the operation of the linkage system 232 on various terrain surfaces.

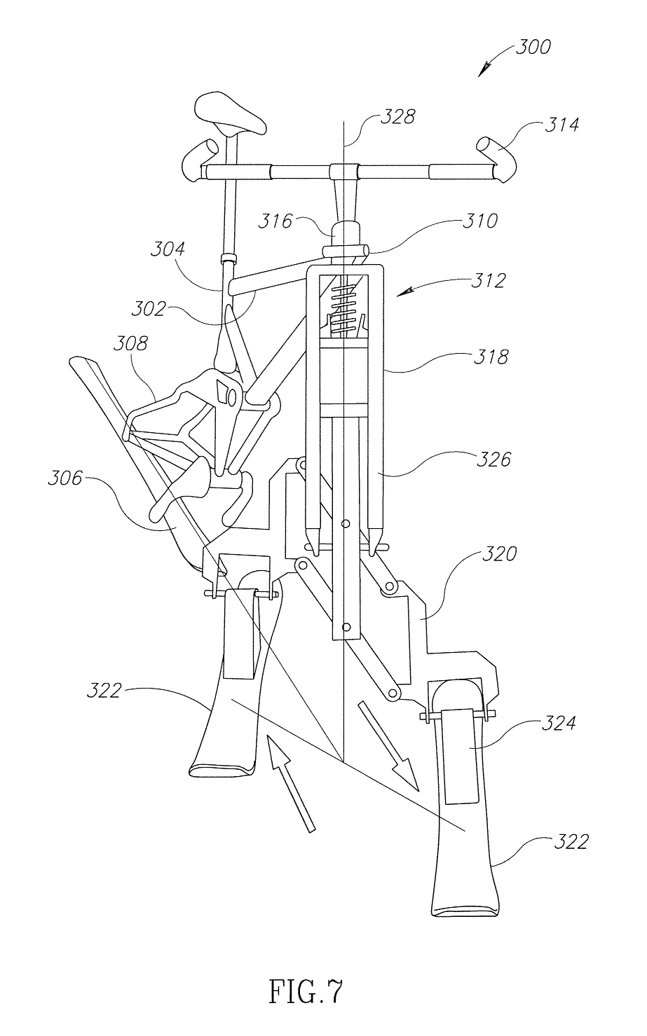

FIG. 7 shows another ski vehicle 300 according to an embodiment of the invention. The ski vehicle 300 includes a main frame 302. In the illustrated embodiment, the main frame 302 is a bicycle frame that has been converted or modified to be used as the frame for the ski vehicle 300. In one aspect, the bicycle frame may be modified by removing the rear triangular frame (not shown), which on a bicycle extends from an aft portion 304 of the main frame 302 to receive the rear wheel. For purposes of clarity and brevity, various aspects and features that are common with a bicycle will not be described in detail, for example the seat and the handlebars. It is appreciated that the various components described below may be obtained as a kit or separately for converting a bicycle to the ski vehicle 300.

The main frame 302 is coupled to a rear ski 306 through a rear frame arrangement 308. A fore portion 310 of the main frame 302 is coupled to a steering assembly 312. The steering assembly includes handlebars 314, a steering post 316, forks 318, and a linkage system 320, which in turn is coupled to two front skis 322 through brackets 324. The linkage system 320 is coupled to the steering forks 318 with member 326. In addition, a rake axis 328 generally indicates an alignment of the steering assembly 312 for the ski bike 300 converted from a modified bike frame 302.

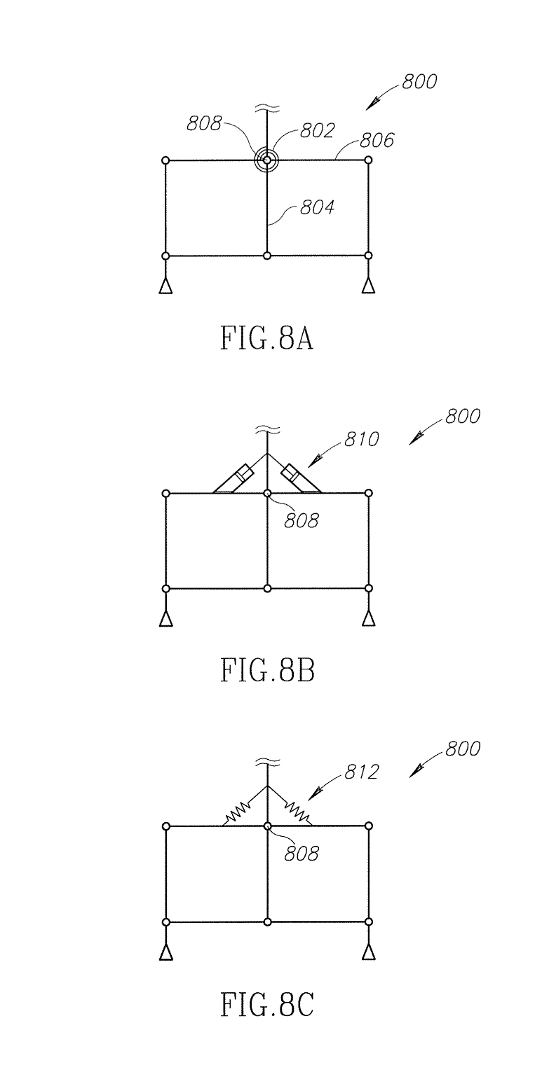

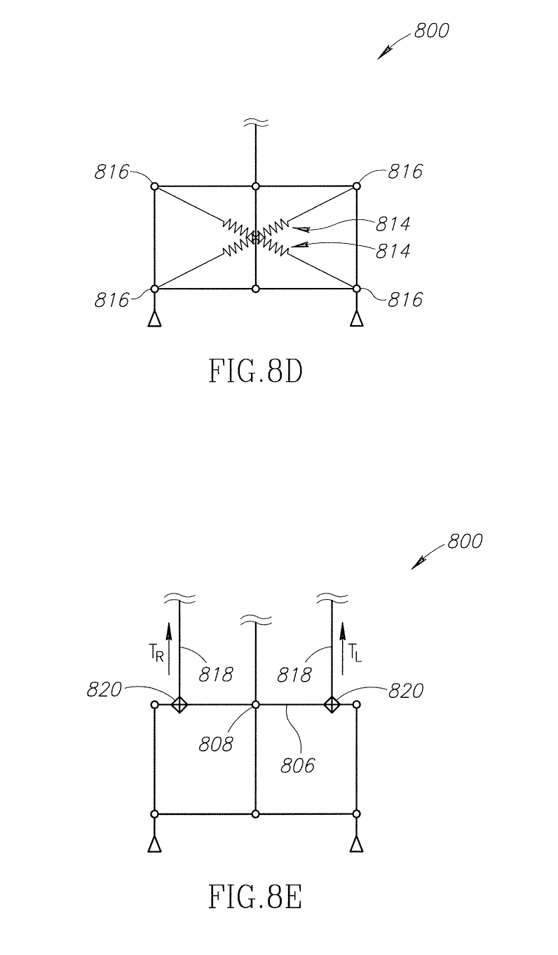

FIGS. 8A through 8E schematically show several embodiments for controlling a position of a linkage system 400. In the illustrated embodiments, the linkage system 800 is a parallelogram linkage system. But, it is appreciated that the concepts herein may be applied to other types of linkage systems. The structural features and connectivity of the linkage system to the ski vehicle are described above and will not be described in further detail herein.

FIG. 8A shows a torsional spring 802 coupled to a center link 804 and to a top link 806. The torsional spring 802 operates to restrain abrupt rotation of the linkage system 800 about an upper pivot joint 808. In addition, the torsional spring 802 may also operate to restore the linkage system 800 (i.e., provides self-restoring forces to the linkage system 800) back to its rectangular or square configuration after a maneuver or after moving the ski vehicle to flat terrain.

FIG. 8B shows dampers 810, which are illustrated as cylinder/piston devices. Similar to the torsional spring above, the dampers 810 tend to restrain abrupt rotation of the linkage system 800 about the upper pivot joint 808 and also provide self-restoring forces.

FIG. 8C shows biasing elements 812, which may be compression springs, for example. The biasing elements 812 tend to restrain abrupt rotation of the linkage system 800 about the upper pivot joint 808 and also provide self-restoring forces.

FIG. 8D shows other biasing elements 814 coupled to corner pivot joints 816. These biasing elements may also be compression springs. Like the biasing elements of the previous embodiment, the biasing elements 814 tend to restrain abrupt rotation of the linkage system 800 and also provide self-restoring forces.

FIG. 8E shows cables 818 extending from fixed locations 820 on the top link 806 of the linkage system 800. The cables 818 are coupled to a steering apparatus (not shown) and manually actuatable by the rider via hand (or foot) calipers (not shown) or a rotatable grip shift (not shown). Hand calipers and rotatable grip shifts are devices that are commonly employed on bicycles to manually actuate a cable brake system and/or to shift gears. In the illustrated embodiment, increasing tension, TL, in the cable 818 coupled to a left handlebar tends to move a left side of the linkage system upward. Conversely, increasing tension, TR, in the cable 818 coupled to a right handlebar tends to move a right side of the linkage system upward. Alternatively, the cable or cables 818 extending from the linkage system 800 could be actuated via the steering assembly 216 (FIG. 4A). By way of example, the cable 818 could cooperate with the rotation of the steering assembly 216 to be tensioned when the ski vehicle is turned by a predetermined amount.

FIG. 9 shows a ski loading apparatus 500 for a ski 502. In the illustrated embodiment, the ski loading apparatus 500 may include a biasing device 504 that places a two-force member 506 in compression and thus loads the ski 502 in a vicinity of a mounting bracket 508. In operation, there may be advantages in loading the front ski tip at the beginning of turns to initiate a faster turn and improve responsiveness. In one embodiment, the loading of the ski 502 is accomplished manually via a cable-actuated hand caliper (not shown) or by a rotatable grip shift (not shown) located on the steering assembly (not shown). In another embodiment, biasing device 504 may be configured to allow a bit of freedom before loading the ski 502. It is appreciated that the biasing device 504 may be calibrated to automatically load or refrain from loading the ski 502.

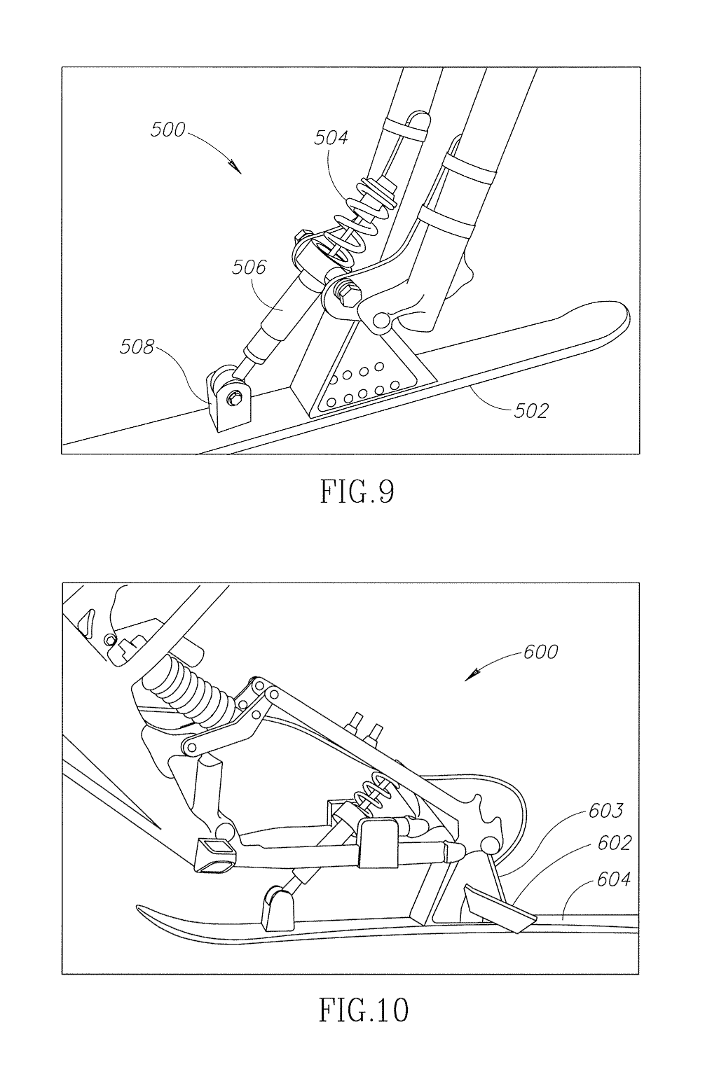

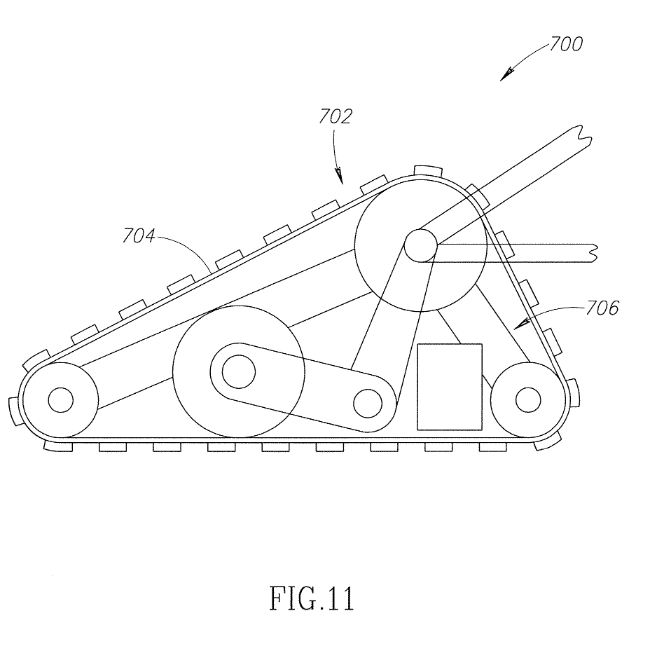

FIG. 10 shows a ski vehicle 600 having a skeg 602 coupled to a rear ski attachment bracket 603. Skegs are typically used on sports equipment, such as surfboards and wakeboards, in order to stabilize the board by resisting a “sliding out” or fishtailing motion. In the illustrated embodiment, the skeg 602 may advantageously improve the ability of a ski 604 to hold its edge better in a curve, as well as on an extreme traverse. In one embodiment, the skeg 602 may be pivotally coupled to the ski vehicle 600 and thus be variably deployable, where the rider selectively urges the skeg 602 into the terrain by a desired amount. The skeg 602 may be actuated by a typical bicycle hand-brake caliper (not shown) or a rotatable grip-shift (not shown). The skeg 602 may also function as a brake when it is placed deep enough to effectively slow and stop the ski vehicle 600. In another embodiment, the skeg 602 is fixed to the ski vehicle 600.

FIG. 11 shows an embodiment for a motorized ski vehicle 700 having a rear terrain engagement device 702. In the illustrated embodiment, the rear terrain engagement device 702 is a modular, motorized drive system. A track 704 is arranged around a drive train 706. The drive system 702module may include a self-contained fuel source (e.g., liquid combustible fuel, natural gas, hydrogen, battery, etc.). The motorized drive system 702 may be powered by a variety of engines or motors that are capable of moving the ski vehicle 700 at a desired speed over varied terrain. The drive train 706 is mounted to the main frame of the ski vehicle 700.

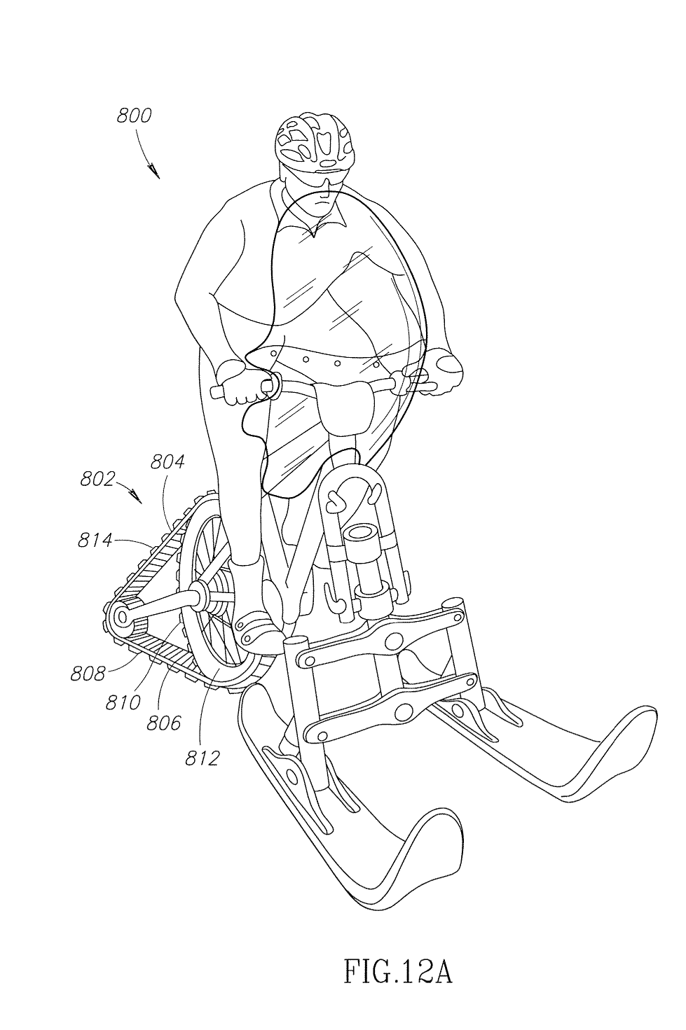

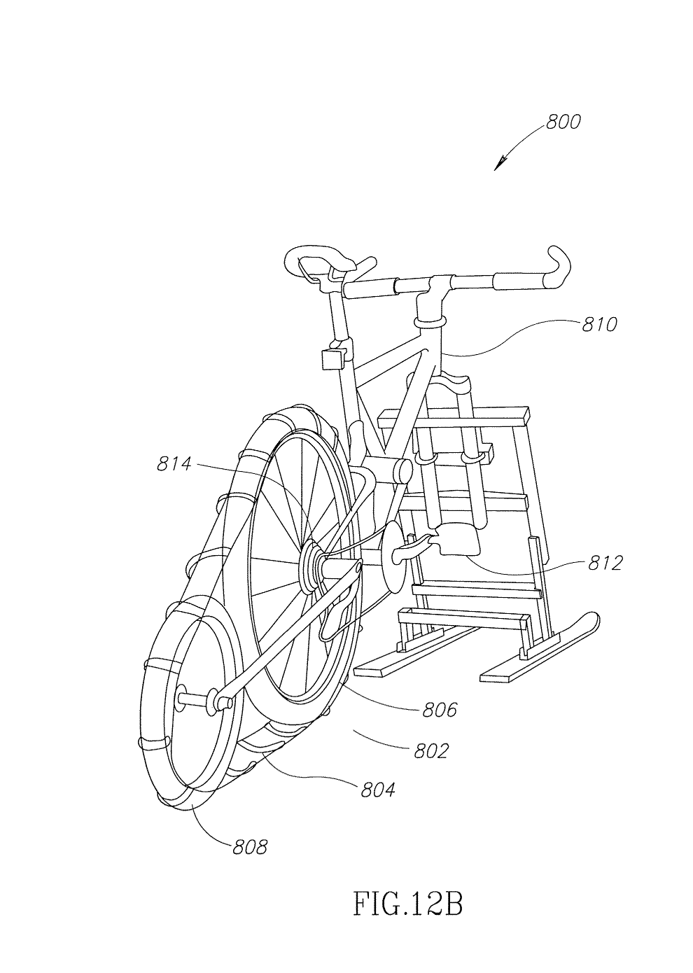

FIGS. 12A and 12B show an embodiment for a human-powered ski vehicle 800 having a rear terrain engagement device 802. The rear terrain engagement device 802 is a track 804 continuously formed around a first wheel 806 and a second wheel 808. The wheels 806, 808 are coupled together with a frame 810. In addition, the ski vehicle 800 includes pedals 812 and a gear system 814, where each may be similarly configured or substantially identical to bicycle components.

In sum, the ski vehicles and components thereof described herein may advantageously provide needed improvements such as more efficient turning, handling, control, and responsiveness of the ski vehicle. In addition, the arrangement and configuration of the steering assembly with respect to the main frame and linkage system, as well as the ability to rotate the linkage system about a rake axis, advantageously provides for improved ski edging and enhanced steering control based on the differential thrust and tilt of the respective front skis.

These and other changes can be made in light of the above detailed description. In general, in the following claims, the terms used should not be construed to limit the invention to the specific embodiments disclosed in the specification and the claims, but should be construed to include all types of ski vehicles and components thereof, to include but not limited to contact plates that operate in accordance with the claims.

While the preferred embodiment of the invention has been illustrated and described, as noted above, many changes can be made without departing from the spirit and scope of the invention. For example, different types of skis, linkage systems, and steering assemblies may be arranged to achieve similar advantages as the ski vehicles described above. Accordingly, the scope of the invention is not limited by the disclosure of the preferred embodiment. Instead, the invention should be determined by reference to the claims that follow.

The embodiments of the invention in which an exclusive property or privilege is claimed are defined as follows:

1. A ski vehicle comprising:
a frame;
a rear terrain engagement device coupled to an aft portion of the frame;
two front terrain engagement devices; and
a steering assembly rotationally coupled to the frame and coupled to the two front terrain engagement devices, the steering assembly having a linkage system, wherein at least a portion of the steering assembly and the linkage system are cooperatively rotatable about a rake angle to maneuver the two front terrain engagement devices in tandem.

2. The ski vehicle of claim 1, wherein the grippable steering apparatus includes handlebars.

3. The ski vehicle of claim 1, wherein the rear terrain engagement device is a ski.

4. The ski vehicle of claim 1, wherein the rear terrain engagement device is a motorized drive system.

5. The ski vehicle of claim 4, wherein the motorized drive system includes a track driven by a motor.

6. The ski vehicle of claim 1, wherein the rear terrain engagement device is a track propelled driven by at least one tire.

7. The ski vehicle of claim 1, wherein the two front terrain engagement devices are skis.

8. The ski vehicle of claim 1, wherein the rake angle is greater than 20 degrees in an aft direction relative to a line extending approximately normal to a terrain surface.

9. The ski vehicle of claim 1, wherein the rake angle includes a range of about 30-40 degrees in an aft direction relative to a line extending approximately normal to a terrain surface.

10. The ski vehicle of claim 1, wherein the linkage system includes at least four linkage members pivotally interconnected.

11. The ski vehicle of claim 1, wherein the linkage system includes an upper link having a different length than a lower link.

12. The ski vehicle of claim 1, further comprising a biasing mechanism cooperatingly coupled to the linkage system to restrain the linkage system during a rotational movement of the linkage system.

13. The ski vehicle of claim 1, further comprising a biasing mechanism cooperatingly coupled to the linkage system to restore the linkage system to a desired configuration.

14. The ski vehicle of claim 1, further comprising a skeg coupled to the ski vehicle to provide increased controllability.

15. The ski vehicle of claim 14, wherein the skeg is coupled to the ski vehicle proximate the rear terrain engagement device.

16. The ski vehicle of claim 15, wherein the skeg is selectively deployable by a desired amount relative to the rear terrain engagement device.

17. The ski vehicle of claim 1, further comprising a brake mechanism coupled to the ski vehicle.

18. The ski vehicle of claim 1, further comprising a manually actuatable loading apparatus coupled to at least one of the terrain engagement devices.

19. The ski vehicle of claim 1, further comprising a seating apparatus coupled to the frame.

20. A ski vehicle comprising:
a frame;
a rear ski coupled to an aft portion of the frame;
two front skis; and
a steering assembly rotationally coupled to the frame and coupled to the two front skis, the steering assembly having a linkage system, wherein at least a portion of the steering assembly and the linkage system are cooperatively rotatable about a rake angle to maneuver the two front skis in tandem and provide a desired edging orientation for at least one of the two front skis.

21. The ski vehicle of claim 20, wherein the rake angle is greater than 20 degrees in an aft direction relative to a line extending approximately normal to a terrain surface.

22. The ski vehicle of claim 20, wherein the rake angle includes a range of about 30-40 degrees in an aft direction relative to a line extending approximately normal to a terrain surface.

23. The ski vehicle of claim 20, wherein the linkage system includes at least four linkage members pivotally interconnected.

24. The ski vehicle of claim 20, wherein the linkage system includes an upper link having a different length than a lower link.

25. The ski vehicle of claim 20, further comprising a biasing mechanism cooperatingly coupled to the linkage system to restrain the linkage system during a rotational movement of the linkage system.

26. The ski vehicle of claim 20, further comprising a biasing mechanism cooperatingly coupled to the linkage system to restore the linkage system to a desired configuration.

27. The ski vehicle of claim 20, further comprising a skeg coupled to the ski vehicle to provide increased controllability.

28. The ski vehicle of claim 20, further comprising a brake mechanism coupled to the ski vehicle.

29. The ski vehicle of claim 20, further comprising a manually actuatable ski loading apparatus coupled to at least one of the front skis.

30. The ski vehicle of claim 20, further comprising a seating apparatus coupled to the frame.

31. A ski vehicle conversion kit comprising:
a bicycle frame modifiable for attachment to at least one rear ski and two front skis; and
a steering assembly rotationally coupled to the frame and coupled to the two front skis, the steering assembly having a linkage system, wherein at least a portion of the steering assembly and the linkage system are cooperatively rotatable about a rake angle to maneuver the two front skis in tandem and provide a desired edging orientation for at least one of the two front skis.

32. The ski vehicle conversion kit of claim 31, wherein the rake angle is greater than 20 degrees in an aft direction relative to a line extending approximately normal to a terrain surface.

33. The ski vehicle conversion kit of claim 31, wherein the rake angle includes a range of about 30-40 degrees in an aft direction relative to a line extending approximately normal to a terrain surface.

34. The ski vehicle conversion kit of claim 31, wherein the linkage system includes at least four linkage members pivotally interconnected.

35. The ski vehicle conversion kit of claim 31, wherein the linkage system includes an upper link having a different length than a lower link.

36. The ski vehicle conversion kit of claim 31, further comprising a biasing mechanism cooperatingly coupled to the linkage system to restrain the linkage system during a rotational movement of the linkage system.

37. The ski vehicle conversion kit of claim 31, further comprising a biasing mechanism cooperatingly coupled to the linkage system to restore the linkage system to a desired configuration.
